(19) United States
(12) Patent Application Publication
(10) Pub. No.: US 2023/0282121 A1
(43) Pub. Date: Sep. 7, 2023

(54) DISPLAYING ELECTROMAGNETIC SPECTRUM INFORMATION FOR UNMANNED AERIAL VEHICLE (UAV) NAVIGATION

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 18/174,239

(22) Filed: Feb. 24, 2023

Related U.S. Application Data
(60) Provisional application No. 63/315,685, filed on Mar. 2, 2022.

(51) Int. Cl. G08G 5/00; G06T 11/00; G06T 15/00; G06T 19/00; G06T 7/70; G01C 21/00

(52) U.S. Cl. CPC G08G 5/0069; G06T 11/00; G06T 15/00; G06T 19/006; G06T 7/70; G08G 5/0026; G01C 21/3807; G01C 21/3837; G06T 2215/16

(57) ABSTRACT

Methods, systems, apparatuses, and computer program products for displaying electromagnetic spectrum information for UAV navigation are disclosed. In a particular embodiment, a method of displaying electromagnetic spectrum information for UAV navigation includes an electromagnetic spectrum awareness controller, of a control device associated with a UAV, that generates a first map layer based on electromagnetic spectrum map data; and displays, on a display of the control device, the first map layer overlaid on a base image.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under (400) feet above ground level (AGL) in airspace where FAA air traffic services are not provided. However, a framework that extends beyond the (400) feet AGL limit is needed. For example, unmanned aircraft that would be used by package delivery services and air taxis may need to travel at altitudes above (400) feet. Such a framework requires technology that will allow the FAA to safely regulate unmanned aircraft.

### SUMMARY

Methods, systems, apparatuses, and computer program products for displaying electromagnetic spectrum information for unmanned aerial vehicle (UAV) navigation are disclosed. In a particular embodiment, a method of displaying electromagnetic spectrum information for UAV navigation includes an electromagnetic spectrum awareness controller, of a control device associated with a UAV, that generates a first map layer based on electromagnetic spectrum map data; and displays, on a display of the control device, the first map layer overlaid on a base image.

As will be explained below, there are many types of ambient and environmental electromagnetic signals that a UAV may encounter during flight. In some cases, such as with control device and data communications signals, it is important that the UAV does not navigate outside of the range of such communication. In other cases, electromagnetic activity could interfere with the UAV's communication and sensor systems. Thus, it is advantageous to provide a UAV user or operator with a visualization of non-visible portions of the electromagnetic spectrum, which can assist the user or operator in safe navigation of the UAV.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system of displaying electromagnetic spectrum information for unmanned aerial vehicle (UAV) navigation according to at least one embodiment of the present disclosure;

FIG. 2 is a block diagram illustrating a particular implementation of a system of displaying electromagnetic spectrum information for UAV navigation according to at least one embodiment of the present disclosure;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 3C is an additional view of the blockchain of FIG. 3A;

FIG. 4 sets forth a block diagram illustrating another implementation of a system displaying electromagnetic spectrum information for UAV navigation;

FIG. 5 is a block diagram illustrating a particular implementation of a method of displaying electromagnetic spectrum information for UAV navigation according to at least one embodiment of the present disclosure;

FIG. 6 is a block diagram illustrating a particular implementation of a method of displaying electromagnetic spectrum information for UAV navigation according to at least one embodiment of the present disclosure;

FIG. 7 is a block diagram illustrating a particular implementation of a method of displaying electromagnetic spectrum information for UAV navigation according to at least one embodiment of the present disclosure;

FIG. 8 is a block diagram illustrating a particular implementation of a method of displaying electromagnetic spectrum information for UAV navigation according to at least one embodiment of the present disclosure;

FIG. 9 is a block diagram illustrating a particular implementation of a method of displaying electromagnetic spectrum information for UAV navigation according to at least one embodiment of the present disclosure;

FIG. 10 is a block diagram illustrating a particular implementation of a method of displaying electromagnetic spectrum information for UAV navigation according to at least one embodiment of the present disclosure;

FIG. 11 is a block diagram illustrating a particular implementation of a method of displaying electromagnetic spectrum information for UAV navigation according to at least one embodiment of the present disclosure;

FIG. 12 is a block diagram illustrating a particular implementation of a method of displaying electromagnetic spectrum information for UAV navigation according to at least one embodiment of the present disclosure;

FIG. 13 is a block diagram illustrating a particular implementation of a method of displaying electromagnetic spectrum information for UAV navigation according to at least one embodiment of the present disclosure; and

FIG. 14 is a block diagram illustrating a particular implementation of a method of displaying electromagnetic spectrum information for UAV navigation according to at least one embodiment of the present disclosure.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

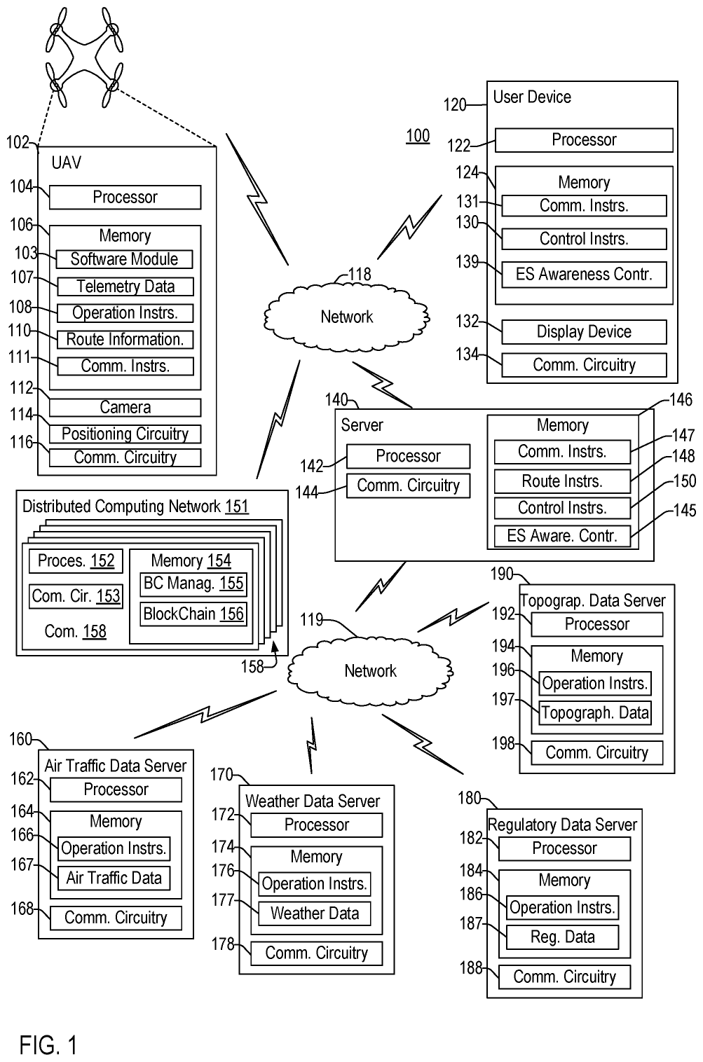

Exemplary methods, apparatuses, and computer program products of displaying electromagnetic spectrum information for UAV navigation in accordance with the present disclosure are described with reference to the accompanying drawings, beginning with FIG. 1. FIG. 1 sets forth a diagram of a system 100 configured of displaying electromagnetic spectrum information for UAV navigation according to embodiments of the present disclosure. The system 100 of FIG. 1 includes an unmanned aerial vehicle (UAV) 102, a user device 120, a server 140, a distributed computing network 151, an air traffic data server 160, a weather data server 170, a regulatory data server 180, and a topographic data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones (drone taxi, flying taxi, or pilotless helicopter) carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the user device 120 or the server 140 that sent the incoming message(s). As will be explained further below, the outgoing and incoming messages may be transaction messages that include information associated with the UAV. Thus, in this implementation, communications between the UAV 102, the user device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

The memory 106 of the UAV 102 may also include communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

In the example of FIG. 1, the memory 106 of the UAV 102 further includes at least one UAV software module 103. The UAV software module 103 is defined as a group of computer executable code that, when executed by a processor, enables at least one specialized functionality of a UAV that may not normally be present on the UAV. For example, in the embodiment of FIG. 1, the camera 112 may normally be configured to take pictures. The UAV software module 103 may be executed by processor 104 to enable additional functionality of the camera 112, such as object detection or tracking. The UAV software module 103 may work in conjunction with the existing hardware of the UAV 102, such as shown in FIG. 1, or in other examples, the UAV software module 103 may work in conjunction with optional hardware. For example, a UAV software module 103 may work in combination with a sensor not normally present on the UAV 102. In such examples, adding the sensor to the UAV 102 may only be enabled once the appropriate software module is enabled. Likewise, the UAV software module 103 may not be functional unless the additional sensor is present on the UAV 102. Examples of functionality that may be enabled by a software module include, but are not limited to, object detection, automated flight patterns, object tracking, object counting, or responses to object detection.

The user device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the user device 120 and to decrypt incoming message(s) using a public key of a device (e.g., the UAV 102 or the server 140 that sent the incoming message(s). Thus, in this implementation, communication between the UAV 102, the user device 120, and the server 140 are secure and trustworthy (e.g., authenticated).

The processor 122 is configured to execute instructions from the memory 124 to perform various operations. The instructions include control instructions 130 that include instructions or code that cause the user device 120 to generate control data to transmit to the UAV 102 to enable the user device 120 to control one or more operations of the UAV 102 during a particular time period, as further described herein.

In the example of FIG. 1, the memory 124 of the user device 120 also includes communication instructions 131 that when executed by the processor 122 cause the processor 122 to transmit to the distributed computing network 151, messages that include control instructions 130 that are directed to the UAV 102. In a particular embodiment, the transaction messages are also transmitted to the UAV and the UAV takes action (e.g., adjusting flight operations), based on the information (e.g., control data) in the message.

In addition, the memory 124 of the user device 120 may also include an electromagnetic spectrum (ES) awareness controller 139. In a particular embodiment, the ES awareness controller 139 includes computer program instructions that when executed by the processor 122 cause the processor 122 to carry out the operations of generating, by a control device associated with an unmanned aerial vehicle (UAV), a first map layer based on electromagnetic spectrum map data; and displaying, on a display of the control device, the first map layer overlaid on a base image. In some variations, generating, by a control device associated with a UAV, a first map layer based on electromagnetic spectrum map data includes one or more of generating, based on controller range map data, a controller range map layer; generating, based on data communications map data, a data communications range map layer; generating, based on radar map data, a radar activity map layer; generating, based on laser map data, a laser activity map layer; generating, based on spectrum activity map data, a spectrum activity map layer; generating, based on interference map data, an interference map layer; and generating, based on UAV information, a UAV sensor range map layer. In an embodiment, the ES awareness controller 139 further includes computer program instructions that when executed by the processor 122 cause the processor 122 to carry out the operations of obtaining, from a map server, the electromagnetic spectrum map data. In an embodiment, the ES awareness controller 139 further includes computer program instructions that when executed by the processor 122 cause the processor 122 to carry out the operations of generating, based on the electromagnetic spectrum map data and a location of the UAV, an alert.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142 is configured to encrypt outgoing message(s) using a private key associated with the server 140 and to decrypt incoming message(s) using a public key of a device (e.g., the UAV 102 or the user device 120 that sent the incoming message(s). As will be explained further below, the outgoing and incoming messages may be transaction messages that include information associated with the UAV. Thus, in this implementation, communication between the UAV 102, the user device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments.

The instructions may also include control instructions 150 that include instructions or code that cause the server 140 to generate control data to transmit to the UAV 102 to enable the server 140 to control one or more operations of the UAV 102 during a particular time period, as further described herein.

In addition, the memory 146 of the server 140 may also include an ES awareness controller 145. In a particular embodiment, the ES awareness controller 145 includes computer program instructions that when executed by the processor 142 cause the processor 142 to carry out the operations of generating, by a control device associated with an unmanned aerial vehicle (UAV), a first map layer based on electromagnetic spectrum map data; and displaying, on a display of the control device, the first map layer overlaid on a base image. In some variations, generating, by a control device associated with a UAV, a first map layer based on electromagnetic spectrum map data includes one or more of generating, based on controller range map data, a controller range map layer; generating, based on data communications map data, a data communications range map layer; generating, based on radar map data, a radar activity map layer; generating, based on laser map data, a laser activity map layer; generating, based on spectrum activity map data, a spectrum activity map layer; generating, based on interference map data, an interference map layer; and generating, based on UAV information, a UAV sensor range map layer. In an embodiment, the ES awareness controller 145 further includes computer program instructions that when executed by the processor 142 cause the processor 142 to carry out the operations of obtaining, from a map server, the electromagnetic spectrum map data. In an embodiment, the ES awareness controller 145 further includes computer program instructions that when executed by the processor 142 cause the processor 142 to carry out the operations of generating, based on the electromagnetic spectrum map data and a location of the UAV, an alert.

In the example of FIG. 1, the memory 146 of the server 140 also includes communication instructions 147 that when executed by the processor 142 cause the processor 142 to transmit to the distributed computing network 151, transaction messages that include control instructions 150 that are directed to the UAV 102.

The distributed computing network 151 of FIG. 1 includes a plurality of computers. An example computer 158 of the plurality of computers is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152 is configured to encrypt outgoing message(s) using a private key associated with the computer 158 and to decrypt incoming message(s) using a public key of a device (e.g., the UAV 102, the user device 120, or the server 140 that sent the incoming message(s). As will be explained further below, the outgoing and incoming messages may be transaction messages that include information associated with the UAV 102. Thus, in this implementation, communication between the UAV 102, the user device 120, the server 140, and the distributed computing network 151 are secure and trustworthy (e.g., authenticated).

The processor 152 is configured to execute instructions from the memory 154 to perform various operations. The memory 154 includes a blockchain manager 155 that includes computer program instructions for utilizing an unmanned aerial vehicle for emergency response. Specifically, the blockchain manager 155 includes computer program instructions that when executed by the processor 152 cause the processor 152 to receive a transaction message associated with a UAV. For example, the blockchain manager may receive transaction messages from the UAV 102, the user device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV 102.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the user device 120, and the server 140 are communicatively coupled via a network 118. For example, the network 118 may include a satellite network or another type of network that enables wireless communication between the UAV 102, the user device 120, the server 140, and the distributed computing network 151. In an alternative implementation, the user device 120 and the server 140 communicate with the UAV 102 via separate networks (e.g., separate short-range networks.

In some situations, minimal (or no) manual control of the UAV 102 may be performed, and the UAV 102 may travel from the origin to the destination without incident. In some examples, a UAV software module may enable the minimal (or no) manual control operation of the UAV 102. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the user device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the user device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple devices of the system 100 in a manner that maintains security of the shared blockchain data structure as a public (i.e., available to other devices) and incorruptible (or tamper evident) ledger. Alternatively, as in FIG. 1, the blockchain data structure 156 is stored in a distributed manner in the distributed computing network 151.

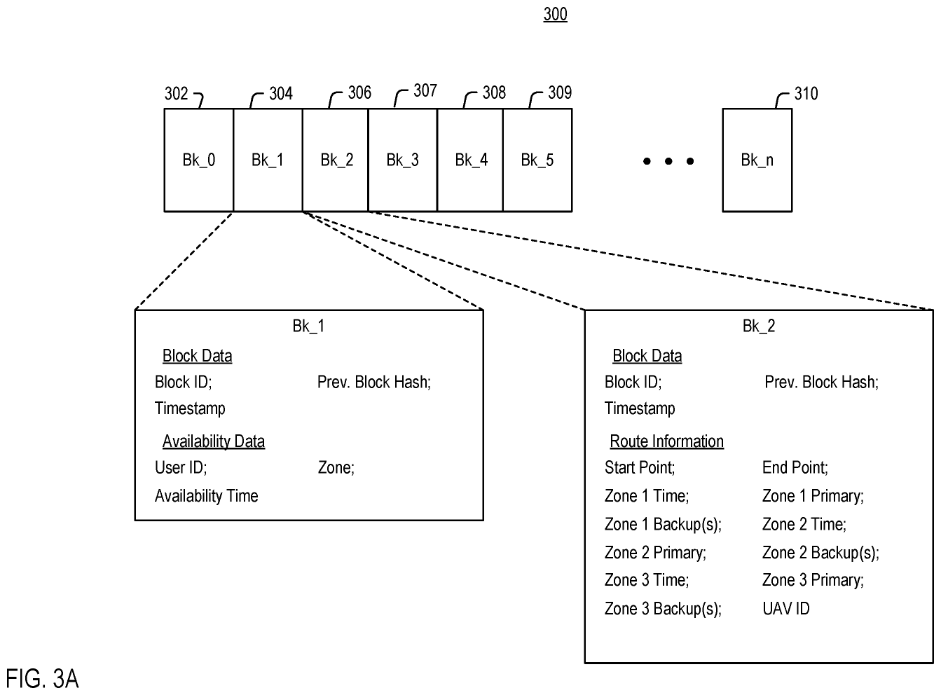

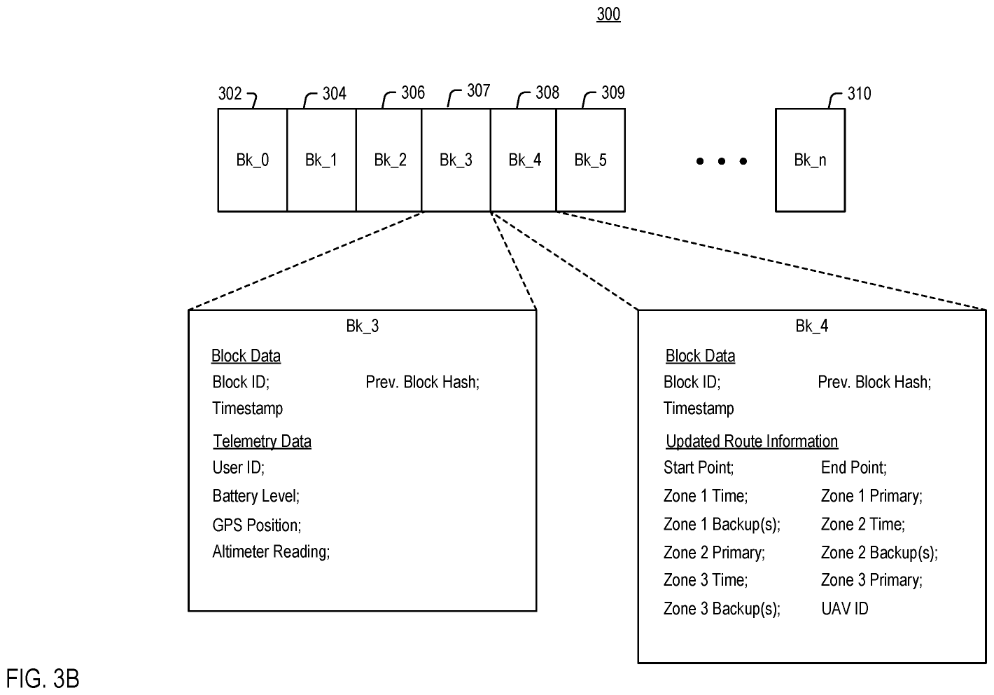

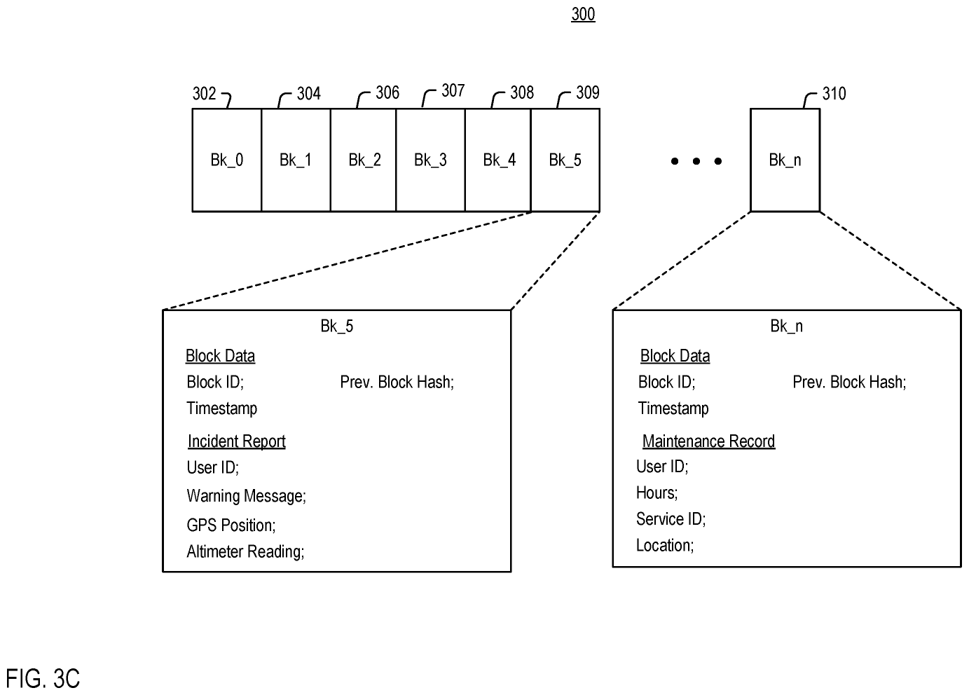

The blockchain data structure 156 may include, among other things, route information associated with the UAV 102, the telemetry data 107, the control instructions 130, and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100 to confirm the integrity of the blockchain data structure 300. For example, the block data also includes a timestamp and a previous block hash. The timestamp indicates a time that the block was created. The block ID may include or correspond to a result of a hash function (e.g., a SHA(256) hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, UAV software modules in use, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain data structure 156.

FIG. 3B also depicts the block BK_4 308 as including updated route information having a start point, an endpoint, and a plurality of zone times and backups, along with a UAV ID. In a particular embodiment, the user device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain data structure 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 may include a UAV software module that is configured to receive telemetry information from an airborne UAV and track the UAV's progress and status. The server 140 is also configured to transmit in-flight commands to the UAV 102. Operation of the user device 120 and the server 140 may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 118 or through direct communication with the server 140. Additionally, communication with each data server may be enabled through the use of a UAV software module as described herein.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 170 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographic data server 190 may include a processor 192, memory 194, and communication circuitry 198. The memory 194 of the topographic data server 190 may include operating instructions 196 that when executed by the processor 192 cause the processor to provide the topographical data that indicates information about terrain, places, structures, transportation, boundaries, hydrography, ortho-imagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, ortho-imagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present disclosure may be implemented on a variety of hardware platforms in addition to those illustrated in FIG. 1.

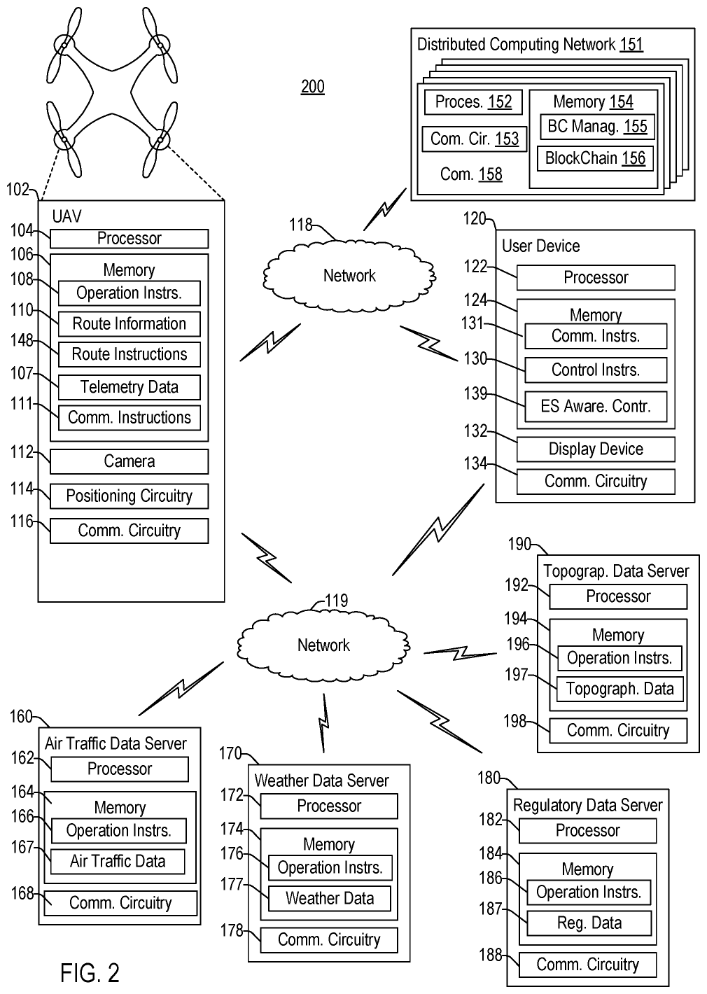

For further explanation, FIG. 2 sets forth a block diagram illustrating another implementation of a system 200 of displaying electromagnetic spectrum information for UAV navigation. Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the user device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

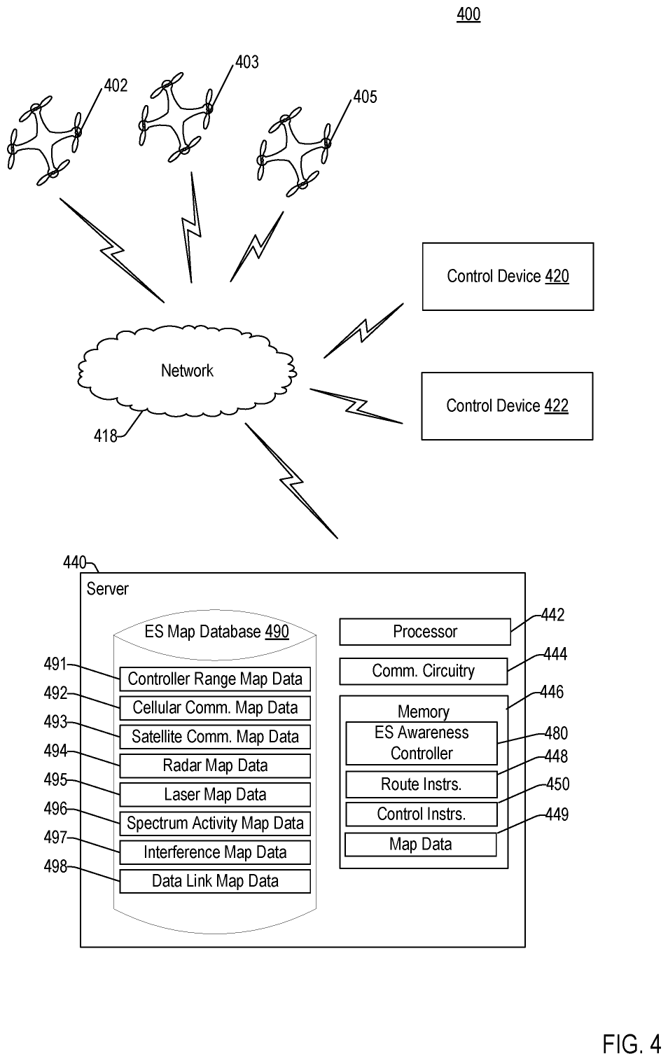

FIG. 4 is a block diagram illustrating a particular implementation of a system 400 for utilizing machine vision to update airspace awareness according to some embodiments of the present disclosure. The system 400 includes the first UAV 402, a second UAV 403, a third UAV 405, which may be similarly configured to the UAV 102 of FIG. 1 and FIG. 2. The system 400 also includes control devices 420, 422 may be similarly configured to the control device 120 of FIG. 1 and FIG. 2. The system 400 also includes a map server 440 that may be implemented by the server 140 of FIG. 1 or by another computing device communicating with the UAVs 402, 403, 405 and/or the control device 420. When the map server 440 is another computing device not depicted in FIG. 1 or FIG. 2, the map server may also include a processor 442 coupled to communication circuitry 444 and a memory 446. The memory 446 may include operating instructions 448 that are configured to transmit map data 449 via the communication circuitry 444 to the UAVs 402, 403, 405 and/or the control devices 420, 422. In some examples. The map data 449 includes data related to an electromagnetic spectrum (ES) awareness map. The memory may also include control instructions 450 that include instructions or code that cause the server 440 to generate control data to transmit to one or more UAVs 402, 403, 405 to enable the server 440 to control one or more operations of the UAV during a particular time period. The memory 446 may also include an ES awareness controller 480 implemented by computer executable instructions that cause processor 442 to carry out the operations of aggregating electromagnetic spectrum information including as one or more of cellular communications information, satellite communications information, radar activity information, laser activity information, spectrum activity information, interference activity information, and so on as described above; extracting location information associated with the electromagnetic spectrum information; and generating electromagnetic spectrum map data. The electromagnetic spectrum map data may include examples of electromagnetic spectrum map data discussed below.

In some embodiments, the map server 440 maintains electromagnetic spectrum (ES) map data in the map database 490. For example, the ES map data in the ES map database 490 may relate to communication and sensor frequencies or other non-visible electromagnetic spectrum information. For example, ES map data may associate an electromagnetic signal frequency with a geographic location (e.g., a GPS coordinate or geographic boundary). In some examples, the ES map data further indicates a strength of the electromagnetic signal. In some examples, the ES map data further indicates a type of the electromagnetic signal (e.g., cellular communications, radar, etc.).

In some examples, the map database 490 includes controller range map data 491. In one example, the controller range map data 491 includes a location of each UAV control device 420, 422 associated with the UAV system 400. The controller range map data 491 may also include the UAV communication range of that control device 420, 422, thus indicating a distance range within which the control device 420, 422 is capable of radio frequency communication with a UAV 402, 403, 405. For example, a particular control device may have a UAV communication range of 6 miles. In such an example, the controller range map data 491 may include information indicating the location of the control device and information indicating a six-mile radius within which the control device is capable of communicating with UAV. In some examples, the controller range map data 491 may include control device location and range information for control devices associated with a fleet of UAVs. In some examples, the location information for each control device 420, 422 is supplied to the map server 440 by that control device 420, 422. In some examples, the communication range information for each control device 420, 422 is supplied to the map server 440 by that control device 420, 422. In some implementations, the ES awareness controller 480 aggregates controller range information relating to various control devices associated with the UAV system 400 and generates the controller range map data 491.

In some examples, the map database 490 includes cellular communications map data 492. In one example, the cellular communications map data 492 includes information relating to the location of cellular communications towers and cellular communication capabilities based on the locations of the cellular communication towers. For example, the cellular communications map may indicate areas where cellular communication is available or unavailable (i.e., cellular coverage). In some examples, the cellular communications map data 492 includes information about frequency bands utilized by the cellular communications towers, which may pertain to the frequency bands utilized by the UAVs 402, 403, 405 for communication. For example, the cellular communications map data 492 may include cellular communications availability or unavailability for the 698-806 MHz band, the 806-849/851-896 MHz band, the 1850-1910/1930-1990 MHz band, and/or the 1710-1755/2110-2155 MHz band. In some examples, the cellular communications map data 492 is based on information obtained from telecommunications providers or carriers. In some implementations, the ES awareness controller 480 aggregates cellular communication information relating to cellular communications networks and generates the cellular communications map data 492.

In some examples, the map database 490 includes satellite communications map data 493. In one example, the satellite communications map data 493 includes information related to satellites and a geographic boundary within which communication with that satellite is available. For example, based on the altitude of the satellite and the curvature of the earth, a direct line of sight to the satellite can only be made within particular locations on the earth (which may also depend on the altitude of the satellite transceiver). Thus, the satellite communications map data 493 may include information relating to satellite communications availability for a particular location, and the specific satellites that are available. In one example, the satellite communication ranges, locations of the satellites (altitude and azimuth), orbit information, and/or other information are provided by satellite communications providers. Where the satellite is geostationary, the satellite communications map data 493 may include information about a fixed communications range. Where the satellite is not geostationary, the satellite communication map data 493 may include communications availability based on a particular location and a particular time of day or schedule. In one example, the satellites to which the satellite communications map data relates are associated with the UAV system 400, e.g., as satellite communication provider satellites that provide satellite communication to the UAV system 400. In some implementations, the ES awareness controller 480 aggregates satellite communication information relating to satellite communications networks and generates the satellite communications map data 493.

In some examples, the map database 490 includes radar map data 494. In one example, the radar map data 494 includes information related to radar sources. The radar sources may be stationary radar sources (e.g., an airport radar system) or moveable radar sources (e.g., radar systems of ships, planes, or portable ground-based radar). In some examples, the radar map data 494 for a radar system includes at least the location of the radar system. In further examples, the radar map data 494 includes the maximum range of the radar system. In still further examples, the radar map data 494 includes the operating frequency (e.g., the frequency band) of the radar system. In some implementations, the range and/or operating frequency of the radar system is estimated based on known attributes of the radar system, such as the purpose of the radar system or whether the radar system is governmental, military, commercial, or personal use. In some examples, the information included in the radar map data 494 is made available by the radar system operator, or by governmental (e.g., the FAA) or military sources. In some examples, the radar system is associated with the UAV system 400. In some implementations, the ES awareness controller 480 aggregates radar system and location information and generates the radar map data 494.

In some examples, the map database 490 includes laser map data 495. In one example, the laser map data 495 includes information related to laser systems such as light detection and ranging (LiDAR) systems or laser communications systems. In some examples, the laser map data 495 for a laser system includes at least the location of the laser system. In further examples, the laser map data 495 includes the maximum range of the laser system. In still further examples, the laser map data 495 includes the operating frequency (e.g., the frequency band) or wavelength of the laser system. In some implementations, the range and/or operating frequency of the laser system is estimated based on known attributes of the laser system, such as the purpose of the laser system whether the radar system is governmental, military, commercial, or person use. In some examples, the information included in the laser map data 495 is made available by the laser system operator, or by governmental or military sources. In some examples, the laser system is associated with the UAV system 400. In some implementations, the ES awareness controller 480 aggregates laser system and location information and generates the laser map data 495.

In some examples, the map database 490 includes spectrum activity map data 496. In one example, the spectrum activity map data 496 includes information relating to activity within a particular frequency band of the electromagnetic spectrum proximate to a particular geographic location. In some examples, spectrum activity map data 496 is based on one or more of the controller range map data 491, the cellular communications map data 492, the satellite communications map data 493, the radar map data 494, and the laser map data 495. For example, for a particular location, the spectrum activity map data 496 may include spectrum activity in the 1900 MHz range relating to cellular communications activity from cellular communications map data 492 and activity in the 8-12 GHz range relating to radar activity from radar map data 494. In some examples, the spectrum activity map data 496 is generated from spectrum activity information collected by a spectrum analyzer (not shown). In one example, a spectrum analyzer may be attached to a component of the UAV system 400, such as a control device 420, 422 or a UAV 402, 403, 405. In such an example, the control device 420, 422 or the UAV 402, 403, 405 may provide the collected spectrum activity data and a corresponding location of the point of collection to the map server 440. In some examples, the spectrum activity information is acquired from independent sources. In one example, the spectrum activity map data 496 is organized into frequency ranges, for example, in 100 MHz or 1000 MHz increments. In another example, the spectrum activity map data 496 is organized into frequency bands recognized by standards organizations (e.g., the Institute of Electrical and Electronics Engineers (IEEE)) or governmental bodies (e.g., the Federal Communications Commission (FCC)). In some examples, the ES awareness controller 480 aggregates spectrum activity and location information and generates the spectrum activity map data 496.

In some examples, the map database 490 includes interference map data 497. In one example, the interference map data 497 includes information relating to areas of communication and/or sensor interference. In some examples, the interference map data 497 includes topological sources of communications and/or sensor interference. For example, topological sources of interference can include mountains, valleys, buildings, and so on. Such topological sources can create dead zones for some or all communications and sensor frequencies. In some examples, the interference map data 497 indicates that a particular location is within a dead zone. In particular examples, the dead zone may be associated with a particular frequency range or band that is affected. In further examples, the interference map data 497 includes information about spectrum activity associated with a particular location. For example, the interference map data 497 can be based on one or more of the controller range map data 491, the cellular communications map data 492, the satellite communications map data 493, the radar map data 494, and the laser map data 495, and the spectrum activity map data 496. In such cases, the interference map data 497 can include spectrum activity information as it relates to particular communications devices or sensors of the UAV. In still further examples, the interference map data 497 can identify areas where some or all frequencies are jammed are intentionally jammed. For example, government and military entities may jam communications and sensor frequencies around sensitive sites. In some cases, malicious actors may jam communications and sensor frequencies. The interference and location information used to generate the interference map data 497 can be, for example, sourced from UAVs 402, 403, 405 or control devices 420, 422 in the UAV system 400 that have experienced the interference and provided information about the interference to the map server 440. In some implementations, the ES awareness controller 480 aggregates interference and location information and generates the laser map data 495.

In some examples, the map database 490 includes data link map data 498. In one example, the data link map data 498 includes information relating to data links between entities, such as the data links between control devices 420, 422 and UAVs 402, 403, 405; data links between control devices 420, 422; data links between control devices 420, 422 or UAVs 402, 403, 405 and UAV servers (e.g., the server 140 in FIG. 1 and the server 440 in FIG. 4), data links between control devices 420, 422 or UAVs 402, 403, 405 and data servers (e.g., the servers 160, 170, 180, 190 of FIGS. 1 and 2); data links between UAVs 402, 403, 405; and so on. The data link information may indicate, for example, the type of data link, the strength of the data link, a communications protocol of the data link, and so on. In some examples, the locations of the entities and information describing the data links between them is sourced from, for example, UAVs, control devices, and servers that participate in or are associated with the UAV system 400.

In some implementations, the map server 440 acts as a central repository for the map database 490 and modifications to it. In these implementations, the server 440 provides ES awareness map data 449 to the UAVs 402, 403, 405 and the control devices 420, 422 for route planning, navigation, and UAV missions. Accordingly, the memory the UAVs 402, 403, 405 or the memory of the control devices 420, 422 may include a local copy of an airspace awareness map generated from ES awareness map data 449. The UAVs 402, 403, 405 or the control device 420 may load an ES awareness map relevant to the intended flight path of the UAV from the map server 440 during prior to initiating a mission. The UAVs 402, 403, 405 or the control device 420, 422 may also load an ES awareness map relevant to the current flight path of the UAV from the map server 440 on-demand while the UAV is in flight. In addition to route planning and navigation, the UAVs 402, 403, 405 and the control device 420, 422 may load an ES awareness map from the map sever 440 that includes tags and locations of objects that are relevant to the UAV's mission. The UAVs 402, 403, 405 or the control device 420, 422 may also generate updates to the ES awareness map database 490 that are provided to the map server 440 based on in-flight observations, and the server 440 may propagate updates received from one UAV to other UAVs.

In a particular embodiment, the UAVs 402, 403, 405, the map server 440, the control devices 420, 422 are coupled for communication to a network 418. The network 418 may include a cellular network, a satellite network or another type of network that enables wireless communication between the UAVs 402, 403, 405, the server 440, the control devices 420, 422. In an alternative implementation, the UAVs 402, 403, 405, the server 440, the control devices 420, 422 communicate with each other via separate networks (e.g., separate short range networks). While only two control devices 420, 422 are illustrated, it will be appreciated that each UAV 402, 403, 405 may be operated by a distinct control device or the same control device.

A UAV may be equipped with any number of sensors that operate in the electromagnetic spectrum and that are configured to each capture data regarding the location or environmental condition of the area in proximity to the UAV. Examples of sensors that may be equipped on a UAV include by are not limited to: GPS sensors; distance sensors (e.g., sensors based on radio detection and ranging); sonar-pulse distance sensing (ultrasonic); time of flight (ToF) sensors (range imaging); light-pulse distance sensing (laser); SONAR, RADAR, and LIDAR; and so on.

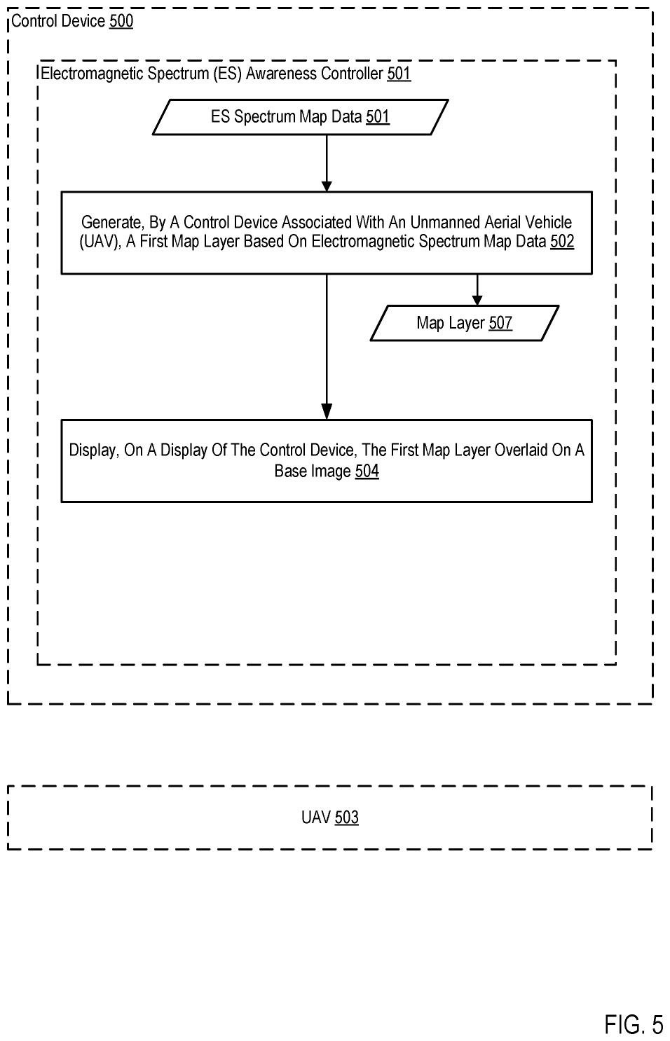

For further explanation, FIG. 5 sets forth a flow chart illustrating an exemplary method of displaying electromagnetic spectrum information for UAV navigation in accordance with at least one embodiment of the present disclosure. An ES awareness controller 501 may include a set of computer program instructions that are executed by a processor. For example, the ES awareness controller 501 of FIG. 5 may be the ES awareness controller 139 of FIGS. 1 and 2 or the ES awareness controller 145 of FIG. 1. The method of FIG. 5 includes generating 502, by a control device 500 associated with a UAV 503, a first map layer 505 based on electromagnetic spectrum map data 507. In some examples, the electromagnetic spectrum map data 507 associates a geographic location or boundary with activity, availability, and capability in the electromagnetic spectrum. The electromagnetic spectrum map data 507 can include, but is not limited to, types of electromagnetic spectrum activity and capability, such as controller range map data, cellular communications map data, satellite communications map data, radar map data, and laser map data, and so on. The electromagnetic spectrum map data 507 can include activity within particular bands or frequency ranges of the electromagnetic spectrum, such as spectrum activity map data, interference map data, and so on.

In some examples, generating 502, by the control device 500 associated with the UAV 503, the first map layer 505 based on electromagnetic spectrum map data 507 may be carried out by the ES awareness controller 501 identifying a geographic area related to a base image and correlating location information described in the electromagnetic spectrum map data 507 with locations visible in the base image. For example, the base image may be a two-dimensional map image. In such an example, a geographic boundary identified from the geographic boundary of the two-dimensional map image may be correlated with location information from the electromagnetic spectrum map data 507. In this example, the first map layer is generated such that the first map layer can overlay the two-dimensional map image with a point-to-point correspondence between data visualized in the first map layer and geographic locations identifiable in the two-dimensional map image. In another example, the base image may be a three-dimensional map image. In such an example, a geographic boundary identified from the geographic boundary of the three-dimensional map image may be correlated with location information from the electromagnetic spectrum map data 507. In this example, the first map layer is generated such that the first map layer can overlay the three-dimensional map image with a point-to-point correspondence between data visualized in the first map layer and geographic locations identifiable in the three-dimensional map image. In yet another example, the base image may be an image from the camera feed of the UAV 503. In such an example, a geographic boundary identified from the geographic boundary of the camera feed image may be correlated with location information from the electromagnetic spectrum map data 507. In this example, the first map layer is generated such that the first map layer is an augmented reality layer that can overlay the camera feed image with a point-to-point correspondence between data visualized in the first map layer and geographic locations identifiable in the camera feed image.

The method of FIG. 5 also includes displaying 504, on a display of the control device 500, the first map layer 505 overlaid on a base image. In some examples, displaying 504, on a display of the control device 500, the first map layer overlaid on a base image may be carried out by the ES awareness controller 501 superimposing the first map layer 505 on a base image, such as a two-dimensional map image, a three-dimensional map image, or an image from the camera feed of the UAV 503. In some examples, the electromagnetic spectrum data in the first map layer 505 is displayed with coloring, hashing, or some other visual indicator of the data. For example, a map layer generated from controller range map data may indicate the range of the control device in a shade of red, where the shaded range is superimposed on a map display that includes the location of the control device. In another example, a map layer is generated from radar activity map data, where radar frequency activity is represented by one or more colors corresponding to one or more frequency ranges or bands of the radar activity. In some implementations, a user interface of the control device display provides a selector to activate and deactivate the display of the map layer.

In some implementations, multiple map layers are generated from the same set of electromagnetic spectrum map data. For example, cellular communications map data may include information about cellular communications in multiple frequency bands, e.g., 900 MHz and 1900 MHz. In such an example, a first map layer is generated for the 900 MHz frequency band map data and a second map layer is generated for the 1900 MHz frequency band. The first and second map layer may use different colors to indicate their respective frequency bands. In some examples, the user interface of the control device display provides a selector to activate and deactivate the first and second map layers based on the type or source of the data (i.e., cellular communications map data) or individually by their frequency bands. For example, activating cellular communications map layer selector would activate both the first and second map layers, whereas activating a 500-1000 MHz frequency selector would activate only the first map layer. In another example, radar activity map data can include electromagnetic spectrum map data that spans multiple different radar bands (e.g., K, Ka, Ku, X, C, S, L) ranging from 1 GHz to 40 GHz. In one example, multiple map layers are generated, where one map layer is generated for each band and one map layer is generated for every increment of an absolute scale (e.g., every 10 GHz), where all of the map layers are associated with the type/source of the data (i.e., radar activity data). In such an example, the user interface may provide a selector to activate each band map layer, a selector to activate each frequency increment map layer, and a radar activity selector that turns all of the map layers on or off.

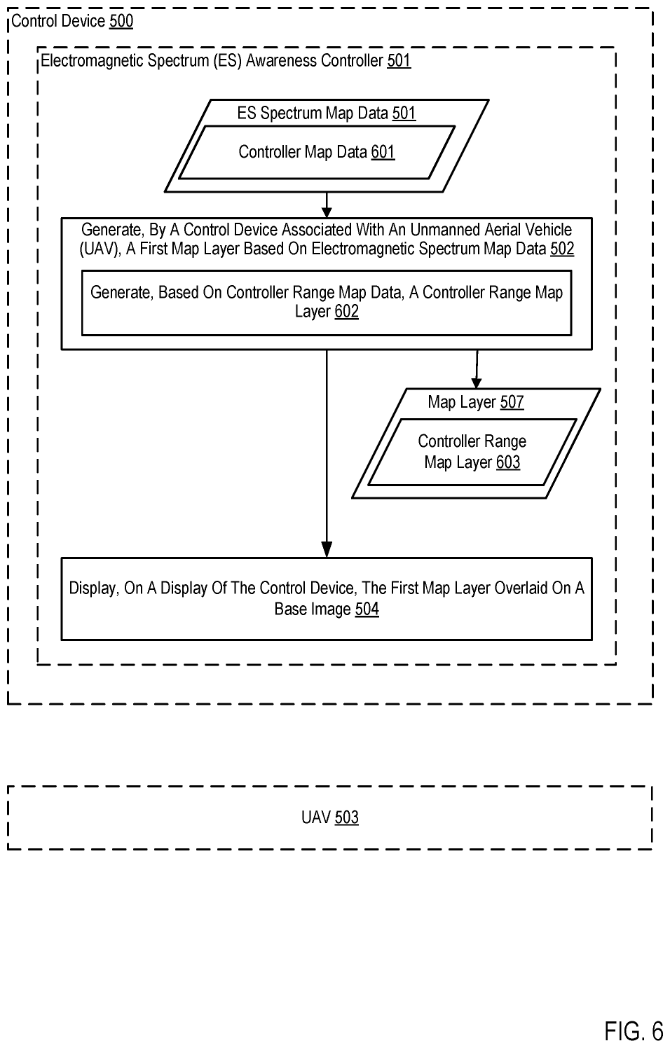

For further explanation, FIG. 6 sets forth a flow chart illustrating another example method for displaying electromagnetic spectrum information for UAV navigation in accordance with some embodiments of the present disclosure. Like the method of FIG. 5, the example method of FIG. 6 also includes generating 502, by the control device 500 associated with the UAV 503, the first map layer 505 based on the electromagnetic spectrum map data 507; and displaying 504, on the display of the control device 500, the first map layer 505 overlaid on the base image.

In the method of FIG. 6, generating 502, by the control device 500 associated with the UAV 503, the first map layer 505 based on the electromagnetic spectrum map data 507 includes generating 602, based on controller range map data 601, a controller range map layer 603. In some examples, the controller range map data 601 includes a location of each UAV control device associated with the UAV system (e.g., the UAV system 100 of FIG. 1, UAV system 200 of FIG. 2, or UAV system 400 of FIG. 4). The controller range map data 601 may also include the UAV communication range of that control device, thus indicating a distance range within which the control device is capable of radio frequency communication with a UAV. For example, a particular control device may have a UAV communication range of 6 miles. In such an example, the controller range map data 601 may include information indicating the location of the control device and information indicating a six-mile radius within which the control device is capable of communicating with a UAV. In some examples, the controller range map data 601 may include control device location and range information for control devices associated with a fleet of UAVs.

In some examples, generating 602, based on controller range map data 601, a controller range map layer 603 may be carried out by the ES awareness controller 501 generating a controller range map layer 603 that indicates the location of each controller in a geographic boundary that is coextensive with the base image, and indicates the range of each controller. For example, the controller range map layer 603 may indicate an area where the ranges of two controllers intersects, such that a handoff of UAV from one controller to the other can be performed in the intersection area.

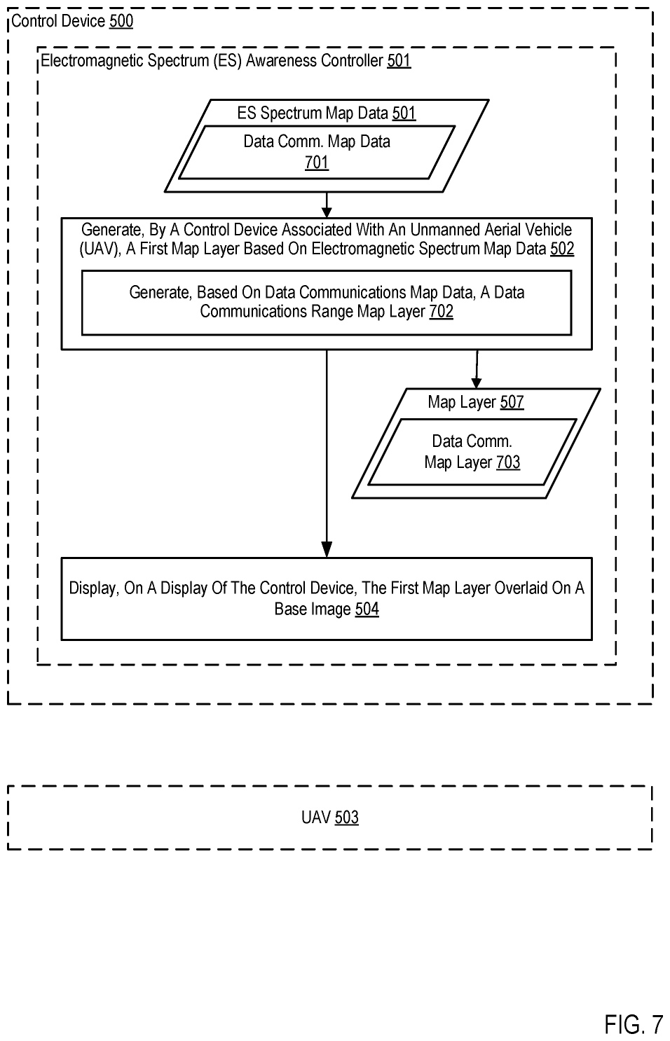

For further explanation, FIG. 7 sets forth a flow chart illustrating another example method for displaying electromagnetic spectrum information for UAV navigation in accordance with some embodiments of the present disclosure. Like the method of FIG. 5, the example method of FIG. 7 also includes generating 502, by the control device 500 associated with the UAV 503, the first map layer 505 based on the electromagnetic spectrum map data 507; and displaying 504, on the display of the control device 500, the first map layer 505 overlaid on the base image.

In the method of FIG. 7, generating 502, by the control device 500 associated with the UAV 503, the first map layer 505 based on the electromagnetic spectrum map data 507 includes generating 702, based on data communications map data 701, a data communications range map layer 703. In some examples, the data communication map data 701 includes cellular communications map data. For example, the cellular communications map data 492 may include information relating to the location of cellular communications towers and cellular communication capabilities based on the locations of the cellular communication towers. For example, the cellular communications map may indicate areas where cellular communication is available or unavailable (i.e., cellular coverage). In some examples, the cellular communications map data 492 includes information about frequency bands utilized by the cellular communications towers, which may pertain to the frequency bands utilized by the UAVs for communication.

In some examples, the data communication map data 701 includes satellite communications map data, such as information related to satellites and a geographic boundary within which communication with that satellite is available. For example, based on the altitude of the satellite and the curvature of the earth, a direct line of sight to the satellite can only be made within a particular location boundary (which may also depend on the altitude of the satellite transceiver). Thus, the satellite communications map data may include information relating to satellite communications availability for a particular location, and the specific satellites that are available. In one example, the satellite communication ranges, locations of the satellites (altitude and azimuth), orbit information, and/or other information are provided by satellite communications providers. Where the satellite is geostationary, the satellite communications map data may include information about a fixed communications range. Where the satellite is not geostationary, the satellite communication map data may include communications availability based on a particular location and a particular time of day or schedule.

In some examples, the data communication map data 701 includes data link map data. In one example, the data link map data includes information relating to data links between entities, such as the data links between control devices and UAVs; data links between control devices; data links between control devices or UAVs and UAV servers, data links between control devices or UAVs and data servers; data links between UAVs; and so on. The data link information may indicate, for example, the type of data link, the strength of the data link, a communications protocol of the data link, and so on.

In some examples, generating 702, based on data communications map data 701, a data communications range map layer 703 may be carried out by the ES awareness controller 501 generating a data communications range map layer 703 visualizing the availability of cellular and satellite communications, or visualizing data links between entities associated with a UAV network, within a geographic boundary that is coextensive with the base image. For example, the data communications range map layer 703 may area where cellular or satellite communications will be lost if the UAV navigates into those areas. In another example, the data communications range map layer graphically indicates a data link, which can be broken depending on the location of two entities in relation to each other. In one example, a separate data communications range map layer is generated for each of the cellular communications, satellite communications, and data link map data.

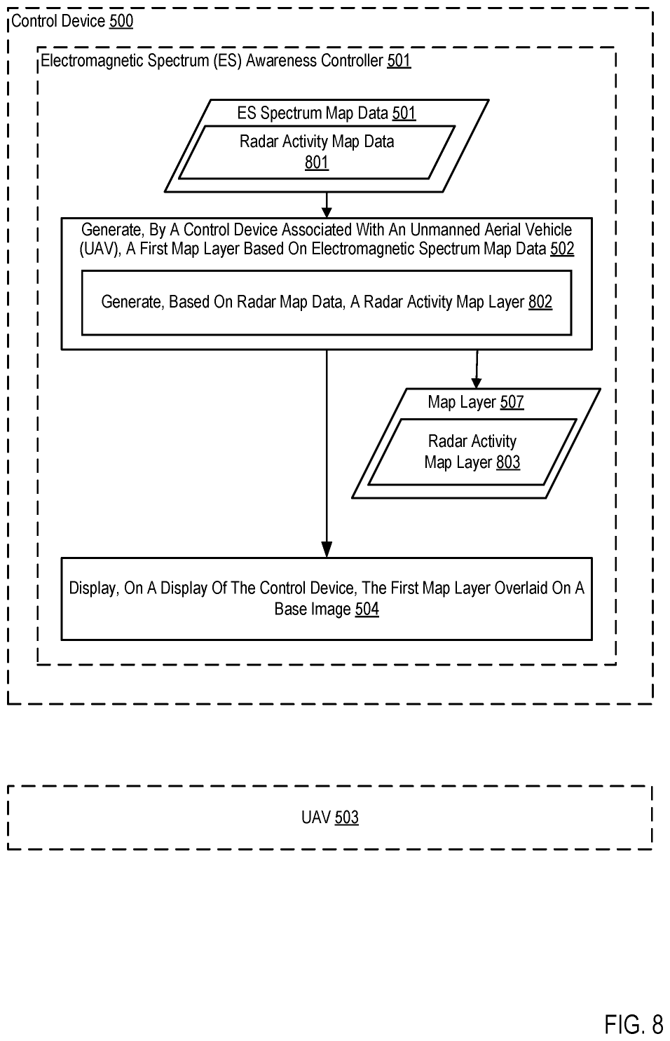

For further explanation, FIG. 8 sets forth a flow chart illustrating another example method for displaying electromagnetic spectrum information for UAV navigation in accordance with some embodiments of the present disclosure. Like the method of FIG. 5, the example method of FIG. 8 also includes generating 502, by the control device 500 associated with the UAV 503, the first map layer 505 based on the electromagnetic spectrum map data 507; and displaying 504, on the display of the control device 500, the first map layer 505 overlaid on the base image.

In the method of FIG. 8, generating 502, by the control device 500 associated with the UAV 503, the first map layer 505 based on the electromagnetic spectrum map data 507 includes generating 802, based on radar map data 801, a radar activity map layer 803. In some examples, the radar map data 801 includes information related to radar sources and their locations and ranges. The radar sources may be stationary radar sources (e.g., an airport radar system) or moveable radar sources (e.g., radar systems of ships, planes, or portable ground-based radar). In some examples, the radar map data 801 for a radar system includes at least the location of the radar system. In further examples, the radar map data 801 includes the maximum range of the radar system. In still further examples, the radar map data 801 includes the operating frequencies (e.g., the frequency bands) of the radar system. In some implementations, the range and/or operating frequency of the radar system is estimated based on known attributes of the radar system, such as the purpose of the radar system or whether the radar system is governmental, military, commercial, or personal use.

In some examples, generating 802, based on radar map data 801, a radar activity map layer 803 may be carried out by the ES awareness controller 501 generating a radar activity map layer 803 indicating radar source locations and associated ranges and operating frequencies within a geographic boundary that is coextensive with the base image. For example, the radar activity map layer 803 can graphically indicate a location of a radar source, a range of the radar, and frequency of the radar signal. Where the radar map data indicates signals of different frequencies, different colors may be used to indicate the different frequencies, frequency bands, or frequency ranges.

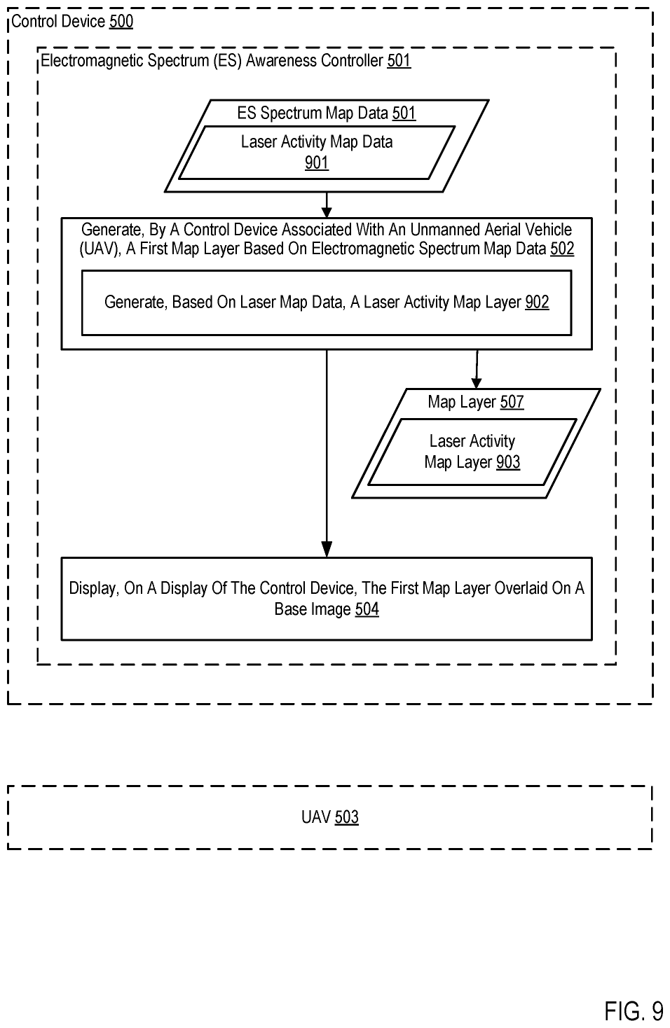

For further explanation, FIG. 9 sets forth a flow chart illustrating another example method for displaying electromagnetic spectrum information for UAV navigation in accordance with some embodiments of the present disclosure. Like the method of FIG. 5, the example method of FIG. 9 also includes generating 502, by the control device 500 associated with the UAV 503, the first map layer 505 based on the electromagnetic spectrum map data 507; and displaying 504, on the display of the control device 500, the first map layer 505 overlaid on the base image.

In the method of FIG. 9, generating 502, by the control device 500 associated with the UAV 503, the first map layer 505 based on the electromagnetic spectrum map data 507 includes generating 902, based on laser map data 901, a laser activity map layer 903. In some examples, the laser map data 901 includes information related to laser systems such as LiDAR systems or laser communications systems. In some examples, the laser map data 901 for a laser system includes at least the location of the laser system. In further examples, the laser map data 901 includes the maximum range of the laser system. In still further examples, the laser map data 901 includes the operating frequency (e.g., the frequency band) or wavelength of the laser system.

In some examples, generating 902, based on laser map data 901, a laser activity map layer 903 may be carried out by the ES awareness controller 501 generating a laser activity map layer 903 graphically indicating laser source locations and associated ranges and operating frequencies within a geographic boundary that is coextensive with the base image.

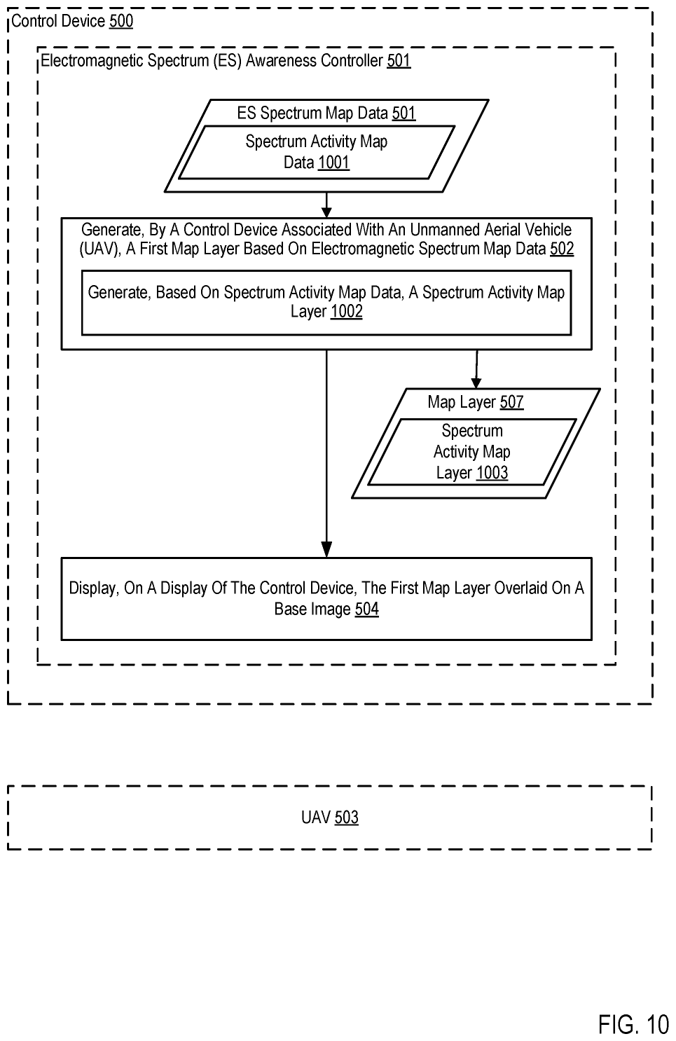

For further explanation, FIG. 10 sets forth a flow chart illustrating another example method for displaying electromagnetic spectrum information for UAV navigation in accordance with some embodiments of the present disclosure. Like the method of FIG. 5, the example method of FIG. 10 also includes generating 502, by the control device 500 associated with the UAV 503, the first map layer 505 based on the electromagnetic spectrum map data 507; and displaying 504, on the display of the control device 500, the first map layer 505 overlaid on the base image.

In the method of FIG. 10, generating 502, by the control device 500 associated with the UAV 503, the first map layer 505 based on the electromagnetic spectrum map data 507 includes generating 1002, based on spectrum activity map data 1001, a spectrum activity map layer 1003. In some examples, the spectrum activity map data 1001 includes information relating to activity within a particular frequency band of the electromagnetic spectrum proximate to a particular geographic location. In some examples, spectrum activity map data 1001 is based other electromagnetic spectrum map data discussed above. For example, for a particular location, the spectrum activity map data 1001 may include spectrum activity in the 1900 MHz range relating to cellular communications activity from cellular communications map data and activity in the 8-12 GHz range relating to radar activity from radar activity map data. In some examples, the spectrum activity map data 1001 is generated from spectrum activity information collected by a spectrum analyzer (not shown). In one example, a spectrum analyzer may be attached to a component of a UAV system, such as a control device or a UAV. In one example, the spectrum activity map data 496 is organized into frequency ranges, for example, in 100 MHz or 1000 MHz increments. In another example, the spectrum activity map data 1001 is organized into frequency bands recognized by standards organizations. In some examples, a map layer 1003 is generated for each frequency increment or frequency band.

In some examples generating 1002, based on spectrum activity map data 1001, a spectrum activity map layer 1003 may be carried out by the ES awareness controller 501 generating a spectrum activity map layer 1003 indicating spectrum activity within a geographic boundary that is coextensive with the base image. Where the spectrum activity map data indicates signals of different frequencies, different colors may be used to indicate the different frequencies, frequency bands, or frequency ranges. In some examples, a spectrum activity map layer may be generated for a particular frequency increment (e.g., 1-2 GHz) or a particular frequency band.

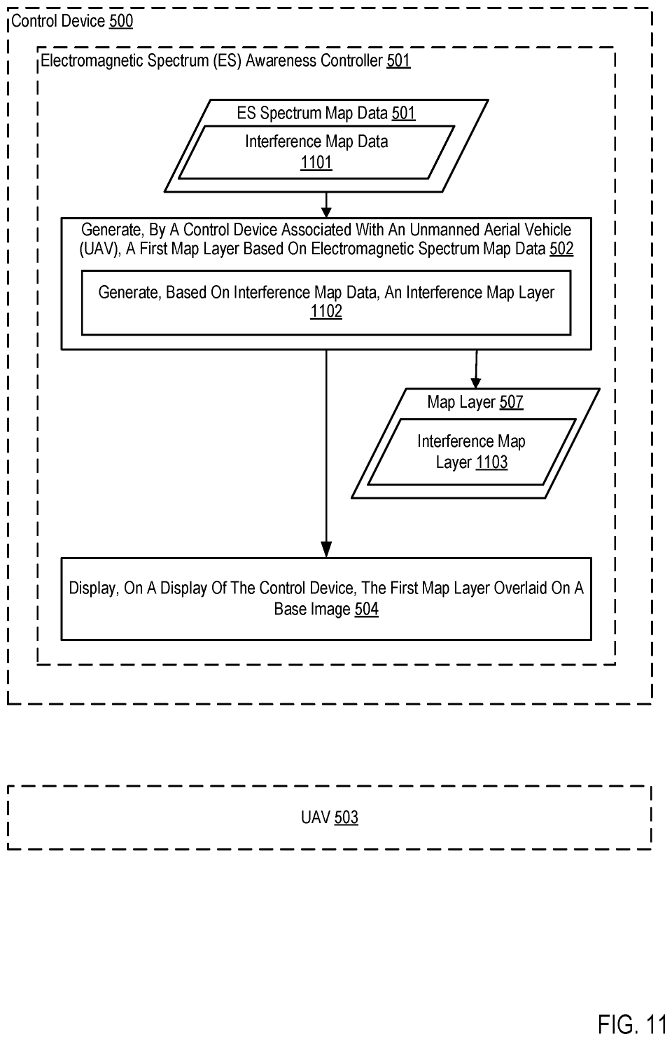

For further explanation, FIG. 11 sets forth a flow chart illustrating another example method for displaying electromagnetic spectrum information for UAV navigation in accordance with some embodiments of the present disclosure. Like the method of FIG. 5, the example method of FIG. 11 also includes generating 502, by the control device 500 associated with the UAV 503, the first map layer 505 based on the electromagnetic spectrum map data 507; and displaying 504, on the display of the control device 500, the first map layer 505 overlaid on the base image.

In the method of FIG. 11, generating 502, by the control device 500 associated with the UAV 503, the first map layer 505 based on the electromagnetic spectrum map data 507 includes generating 1102, based on interference map data 1101, an interference map layer 1103. In some examples, the interference map data 1101 includes information relating to areas of communication and/or sensor interference. In some examples, the interference map data 1101 includes topological sources of communications and/or sensor interference. For example, topological sources of interference can include mountains, valleys, buildings, and so on. Such topological sources can create dead zones for some or all communications and sensor frequencies. In some examples, the interference map data 1101 indicates that a particular location is within a dead zone. In particular examples, the dead zone may be associated with a particular frequency range or band that is affected. In further examples, the interference map data 1101 includes information about spectrum activity associated with a particular location. For example, the interference map data 497 can be based other electromagnetic spectrum map data discussed above. In such cases, the interference map data 1101 can include spectrum activity information as it relates to particular communications devices or sensors of the UAV. In still further examples, the interference map data 1101 can identify areas where some or all frequencies are jammed are intentionally jammed. For example, government and military entities may jam communications and sensor frequencies around sensitive sites. In some cases, malicious actors may jam communications and sensor frequencies.

In some examples generating 1102, based on interference map data 1101, an interference map layer 1103 may be carried out by the ES awareness controller 501 generating an interference map layer 1103 indicating electromagnetic interference within a geographic boundary that is coextensive with the base image. Where the interference map data indicates signals of different frequencies, different colors may be used to indicate the different frequencies, frequency bands, or frequency ranges. In some examples, a spectrum activity map layer may be generated for a particular frequency increment (e.g., 1-2 GHz) or a particular frequency band.

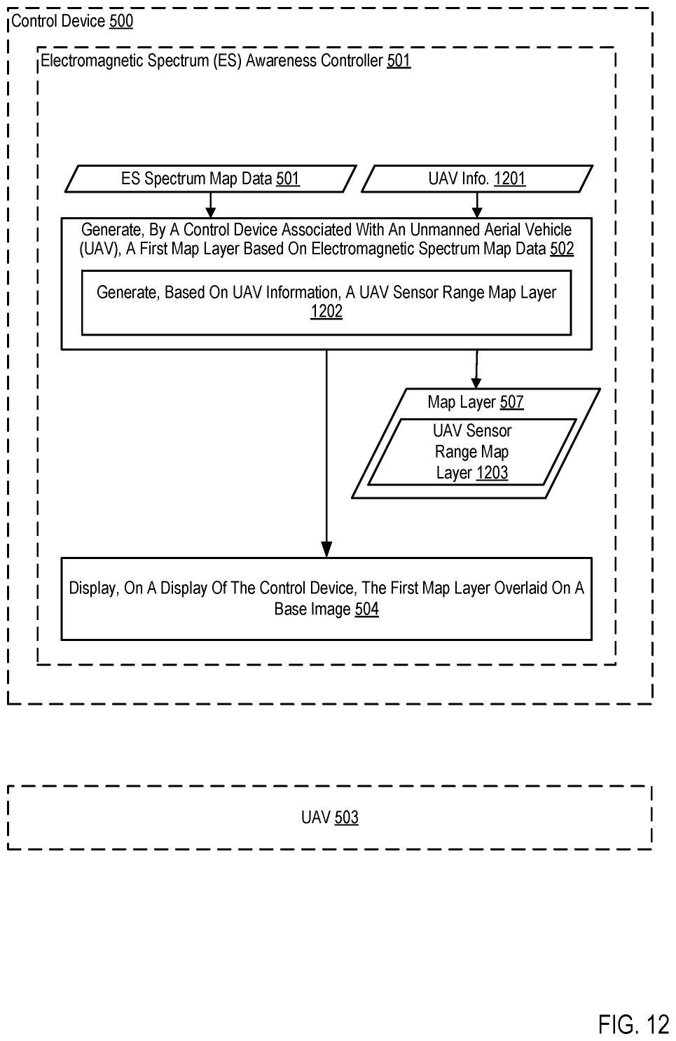

For further explanation, FIG. 12 sets forth a flow chart illustrating another example method for displaying electromagnetic spectrum information for UAV navigation in accordance with some embodiments of the present disclosure. Like the method of FIG. 5, the example method of FIG. 12 also includes generating 502, by the control device 500 associated with the UAV 503, the first map layer 505 based on the electromagnetic spectrum map data 507; and displaying 504, on the display of the control device 500, the first map layer 505 overlaid on the base image.

The method of FIG. 12 also includes generating 1202, based on UAV information 1201, a UAV sensor range map layer 1203. In some examples, generating 1202, based on UAV information 1201, a UAV sensor range map layer 1203 may be carried out by the ES awareness controller 501 identifying UAV information 1201 that describes on-board sensors. For example, the UAV information 1201 may describe the range of a radar system, or operating characteristics (e.g., power, frequency, minimum detectable signal, etc.) from which the range of the radar system can be calculated. Similarly, the UAV information 1201 may describe capabilities and characteristics of other sensor systems such as a LiDAR system, SONAR system, IR system, and so on. In some examples, the UAV information 1201 is obtained from the UAV 503 itself. In other examples, the UAV information 1201 is obtained from a database. In some implementations, generating 1202, based on UAV information 1201, a UAV sensor range map layer 1203 may be carried out by the ES awareness controller 501 may also be carried out by generating one or more map layers that indicate the range of one or more sensor systems. For example, the ES awareness controller 501 may generate a radar sensor range map layer that visualizes or graphically indicates the range of the radar sensor equipped on the UAV 503. The ES awareness controller 501 may also generate other map layers for other sensor systems, such as a LiDAR sensor range map layer that visualizes the range of the LiDAR sensor equipped on the UAV 503. In some examples, a user interface of the control device 500 includes selectors to activate and deactivate the various sensor range map layers that are available for the UAV 503.

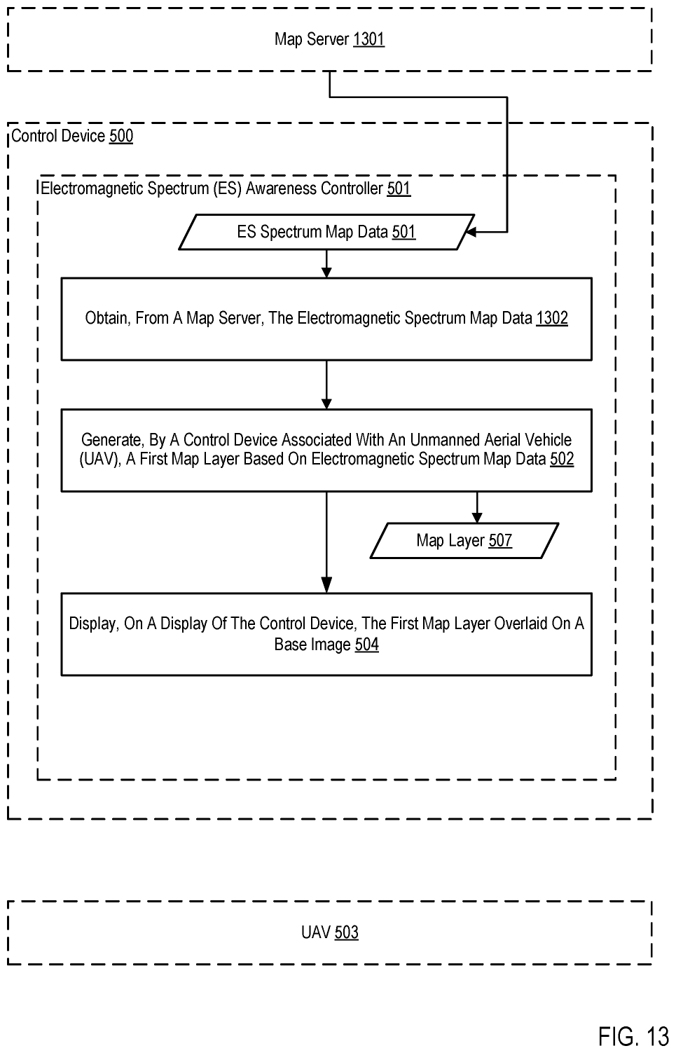

For further explanation, FIG. 13 sets forth a flow chart illustrating another example method for displaying electromagnetic spectrum information for UAV navigation in accordance with some embodiments of the present disclosure. Like the method of FIG. 5, the example method of FIG. 13 also includes generating 502, by the control device 500 associated with the UAV 503, the first map layer 505 based on the electromagnetic spectrum map data 507; and displaying 504, on the display of the control device 500, the first map layer 505 overlaid on the base image.

The method of FIG. 13 also includes obtaining 1302, from a map server 1301, the electromagnetic spectrum map data 507. In some examples, obtaining 1302, from a map server 1301, the electromagnetic spectrum map data 507 may be carried out by the ES awareness controller 501 requesting the electromagnetic spectrum map data 507 for a particular geographic area from the map server 1301 (e.g., the map server 440 of FIG. 4). For example, the geographic area may correspond to the present location of the UAV 503, a flight path of the UAV, or some other geographic location associated with a UAV mission. In one example, the map server 1301 may aggregate electromagnetic spectrum information such as one or more of cellular communications information, satellite communications information, radar activity information, laser activity information, spectrum activity information, interference activity information, and so on as described above. In some implementations, the map server 1301 extracts location information associated with the electromagnetic spectrum information and generates electromagnetic the spectrum map data 507. In some examples, obtaining 1302, from a map server 1301, the electromagnetic spectrum map data 507 may further be carried out by the ES awareness controller 501 receiving the electromagnetic spectrum map data 507 from the map server 1301.

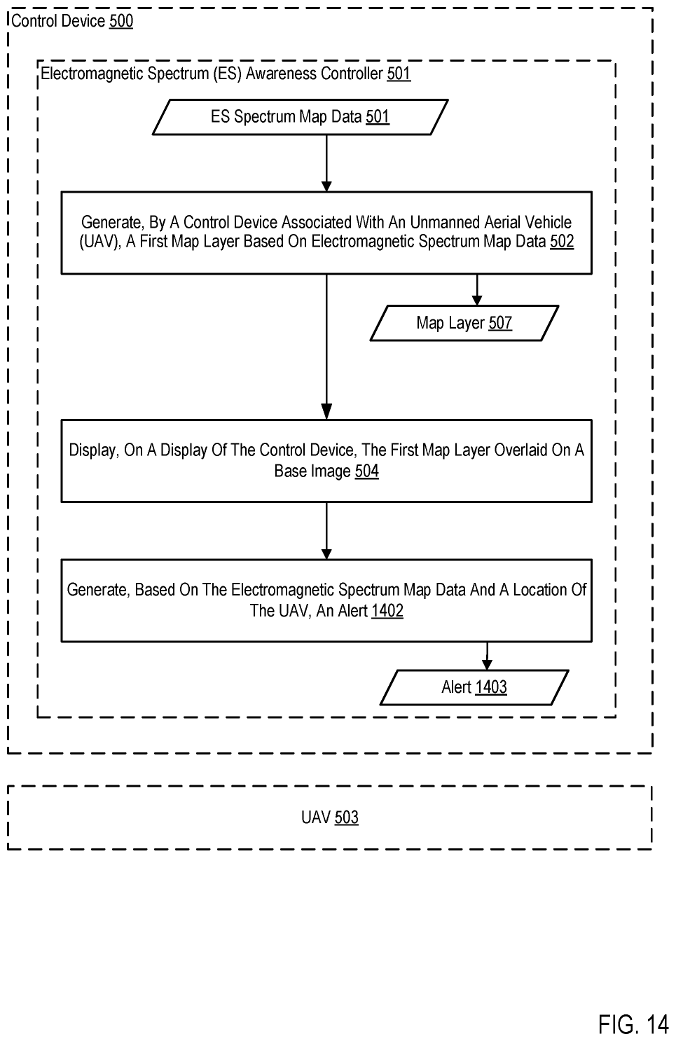

For further explanation, FIG. 14 sets forth a flow chart illustrating another example method for displaying electromagnetic spectrum information for UAV navigation in accordance with some embodiments of the present disclosure. Like the method of FIG. 5, the example method of FIG. 14 also includes generating 502, by the control device 500 associated with the UAV 503, the first map layer 505 based on the electromagnetic spectrum map data 507; and displaying 504, on the display of the control device 500, the first map layer 505 overlaid on the base image.

The method of FIG. 14 also includes generating 1402, based on the electromagnetic spectrum map data 507 and a location of the UAV, an alert 1403. In some examples, generating 1402, based on the electromagnetic spectrum map data 507 and a location of the UAV, an alert 1403 may be carried out by the ES awareness controller 501 identifying, based on electromagnetic spectrum information represented in the electromagnetic spectrum map data 507 that the UAV 503 is navigating into an area in which the operation of the UAV 503 may be affected by electromagnetic activity or the availability of communication. For example, the ES awareness controller 501 may detect that the UAV is about to navigate outside of the range of controller communication, cellular communication, and/or satellite communication, or that a data link will be lost. In another example, the ES awareness controller 501 may detect that the UAV 503 is about to navigate into an area of high electromagnetic activity or interference that may affect the operation of UAV sensors (e.g., radar, LiDAR). In another example, the ES awareness controller 501 may detect that the UAV is about to navigate into a dead zone. In response to detecting that the UAV 503 is navigating into an area in which the operation of the UAV 503 may be affected, the ES awareness controller 501 may generate an alert to a user, operator, or autonomous flight control system indicating an aspect of UAV operation that may be affected in the area.

Exemplary embodiments of the present disclosure are described largely in the context of a fully functional computer system for managing UAV software modules. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of displaying electromagnetic spectrum information for unmanned aerial vehicle (UAV) navigation, the method comprising:
generating, by a control device associated with a UAV, a first map layer based on electromagnetic spectrum map data; and
displaying, on a display of the control device, the first map layer overlaid on a base image.

2. The method of claim 1, wherein the base image is a two-dimensional map image; and
wherein the first map layer is a two-dimensional map layer.

3. The method of claim 1, wherein the base image is a three-dimensional map image; and
wherein the first map layer is a three-dimensional map layer.

4. The method of claim 1, wherein the base image is obtained from a camera feed of the UAV; and wherein the first map layer an augmented reality layer.

5. The method of claim 1, wherein generating, by a control device associated with a UAV, a first map layer based on electromagnetic spectrum map data includes:
generating, based on controller range map data, a controller range map layer.

6. The method of claim 1, wherein generating, by a control device associated with a UAV, a first map layer based on electromagnetic spectrum map data includes:
generating, based on data communications map data, a data communications range map layer.

7. The method of claim 1, wherein generating, by a control device associated with a UAV, a first map layer based on electromagnetic spectrum map data includes:
generating, based on radar map data, a radar activity map layer.

8. The method of claim 1, wherein generating, by a control device associated with a UAV, a first map layer based on electromagnetic spectrum map data includes:
generating, based on laser map data, a laser activity map layer.

9. The method of claim 1, wherein generating, by a control device associated with a UAV, a first map layer based on electromagnetic spectrum map data includes:
generating, based on spectrum activity map data, a spectrum activity map layer.

10. The method of claim 1, wherein generating, by a control device associated with a UAV, a first map layer based on electromagnetic spectrum map data includes:
generating, based on interference map data, an interference map layer.

11. The method of claim 1, wherein generating, by a control device associated with a UAV, a first map layer based on electromagnetic spectrum map data includes:
generating, based on UAV information, a UAV sensor range map layer.

12. The method of claim 1 further comprising:
obtaining, from a map server, the electromagnetic spectrum map data.

13. The method of claim 1 further comprising:
generating, based on the electromagnetic spectrum map data and a location of the UAV, an alert.

14. An apparatus for displaying electromagnetic spectrum information for unmanned aerial vehicle (UAV) navigation, the apparatus comprising:
a processor; and
a non-transitory computer readable medium storing instructions that when executed by the processor, cause the apparatus to carry out operations including:
generating, by a control device associated with a UAV, a first map layer based on electromagnetic spectrum map data; and
displaying, on a display of the control device, the first map layer overlaid on a base image.

15. The apparatus of claim 14, wherein generating, by a control device associated with a UAV, a first map layer based on electromagnetic spectrum map data includes:
generating, based on UAV information, a UAV sensor range map layer.

16. The apparatus of claim 14, the operations further comprising:
obtaining, from a map server, the electromagnetic spectrum map data.

17. The apparatus of claim 14, the operations further comprising:
generating, based on the electromagnetic spectrum map data and a location of the UAV, an alert.

18. A computer program product of displaying electromagnetic spectrum information for unmanned aerial vehicle (UAV) navigation, the computer program product disposed upon a non-transitory computer readable medium, the computer program product comprising computer program instructions that, when executed, cause a computer to carry out the operations of:
generating, by a control device associated with a UAV, a first map layer based on electromagnetic spectrum map data; and
displaying, on a display of the control device, the first map layer overlaid on a base image.

19. The computer program product of claim 18, the operations further including:
obtaining, from a map server, the electromagnetic spectrum map data.

20. The computer program product of claim 18, the operations further including:
generating, based on the electromagnetic spectrum map data and a location of the UAV, an alert.
